(19) United States
(12) Patent Application Publication
(10) Pub. No.: US 2012/0125651 A1
(43) Pub. Date: May 24, 2012

(54) Method and apparatus for reduction of skin effect losses in electrical conductors

(76) Inventor: Timothy Raymond Pearson, Belvidere, IL (US)

(21) Appl. No.: 12/927,646

(22) Filed: Nov. 18, 2010

(51) Int. Cl. H01B 9/00; H01B 9/02

(52) U.S. Cl. 174/24; 174/102 R; 174/103

(57) ABSTRACT

A novel method of reducing the undesired skin effect in electrical conductors is presented. Specific applications including efficient power transmission and high frequency magnetic field generation are discussed, and the advantages over prior art are mentioned. The present invention modifies the inductance of a given conductor with depth into said conductor, allowing the current flowing in the surface of the conductor due to skin effect to diffuse through the remaining conductor area. Inductance is modified in a distributed, continuous fashion via external magnetic structures, ensuring both manufacturability and usability of the resultant conductor. When skin effect inside a conductor is reduced, power loss of transmitted electrical signals is reduced accordingly. Therefore, the present invention represents a significant improvement over prior art.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPPENDIX

Not Applicable

### BACKGROUND OF THE INVENTION

Without limiting the scope of the invention, its background will be discussed within the framework of general electromagnetics. A significant and persistent problem in high frequency electrical circuits is high loss caused by the skin effect. The skin effect is caused by current crowding near the surface of a conductor, and reduces the effective cross sectional area available for conduction in proportion to the square root of applied signal frequency. At relatively high frequencies, for example those above 1 MHz, the skin depth is less than 0.1 mm. This causes a highly undesirable reduction in effective conductor area, and a corresponding increase in conductor resistive loss. Furthermore, as resistive loss increases with the square of current density, and skin effect increases current density proportionally to the square root of frequency, the net result is that the skin-effect resistive power losses increase linearly with increasing frequency. This situation is highly undesirable, as it prevents the efficient transmission of large amounts of high frequency electrical energy through reasonably sized conductors. Additionally, the skin effect can introduce distortion into the applied electrical signal via nonlinear delay in the inner portions of the wire. Finally, high frequency, high magnetic field generation has been historically limited by the skin effect, as overcoming the resultant high losses requires both additional high frequency electrical power and extensive cooling of the entire generation apparatus to remove the wasted energy.

Many attempts have been made over time to solve this problem. One of the earliest known effective systems to achieve this goal is Litzendraht wire, which still is in use today. Unfortunately, it suffers from a number of limitations, including high DC resistance and reduced function above 2 MHz. Other systems have been described over time, but were not successfully commercialized. Examples of such work with laminated conductors are given in “Reduction of Skin-Effect Losses by the Use of Laminated Conductors” by A. M. Clogston (1951), and “Implementation of Multilayered Conductor Structures on RF Cavity Surfaces” by Y. Iwashita (2010). While these existing systems are a significant step forward from Litzendraht wire, their complex structures and limited usefulness have severely inhibited commercialization.

Other prior art, which does not aim to reduce skin-effect losses but bears a resemblance to certain embodiments of the present invention, includes U.S. Pat. No. 4,843,356 and U.S. Patent Application 2006/0267705. The former presents a method for including a distributed shunt inductance in the insulation of an electrical cable in order to compensate for undesired shunt capacitance therein. The method and structures described are not designed to and will not function to reduce the skin effect in conductive elements, despite superficial similarities to the structure of the present invention. Specifically, it should be noted that in the prior art, magnetic material completely encloses a circular conductive element; it is physically impossible for such a structure to selectively alter inductance by conductor depth, which is required for the functioning of the present invention. In another prior embodiment, a segmented cable is presented; however, the conductor gaps in that cable are vertical, not slanted as in the present invention; therefore, the prior art cannot reduce the skin effect as shown due to an absence of external magnetic field modification from that generated by an ideal, single filament. Finally, no attempt to control relative width, height, and spacing of structure elements is shown in the prior art, whereas precise control of these parameters is required to realize a reduction in skin-effect losses via the method shown in the present invention. It is specifically stated in the prior art that adjusting such parameters has little or no effect on the prior invention; this also shows that the methods, structures, and effects of the prior art are substantially different than the methods, structures, and effects of the present invention.

The latter patent application describes a method of equalizing skin-effect losses across frequency. This differs from the present invention in that the prior art increases resistance at DC and low frequencies instead of lowering high frequency resistance. The difference in structure and function is substantial, with the prior art being wholly unsuited for high power, high frequency signal transmission due to its large resistance and subsequent power loss.

A final class of prior art has recently emerged in “Magnetic-Multilayered Interconnects Featuring Skin Effect Suppression” by Y. Zhuang et. al. (2008). This prior art uses a multilayered structure to generate an effective negative permeability above a critical frequency. The present invention does not use interleaved conductors and magnetic materials to achieve reduction in skin effect as shown in the prior art. Additionally, it does not suffer from the effective frequency limitation of the prior art, or the manufacturing difficulties associated with such a structure.

### BRIEF SUMMARY OF THE INVENTION

This invention provides a new method and apparatus for the reduction of skin-effect losses in an electrical conductor of arbitrary shape. The invention consists of a central conductor or laminated conductor stack, near which are placed one or more low-loss magnetic films. These magnetic films are offset from the conductor surface and/or each other via a low-loss dielectric such as PTFE. Additionally, these magnetic films either may be continuous or broken into discrete segments depending on the material utilized. Precise control of film thickness, insulator thickness, and total conductor thickness is mandatory to achieve the largest reduction in skin-effect losses.

Without limiting the scope of the invention, a specific conductor type and shape will be discussed below so as to provide an example of the functional principles disclosed in the present invention. Starting with a laminated stack of identical copper films, where each film has a thickness much less than its width or length, and such films are interleaved vertically with thin insulating films of similar aspect ratio, it can be shown that the mutual inductance of the outer conductors is much less than that of the inner conductors. This is the essence of the skin effect from an electrical perspective: specifically, that the inner conductor impedance is significantly higher than the outer conductor impedance. Under such conditions, standard circuit theory predicts that the majority of the current will flow in the outer conductors, and, in fact, such predictions exactly match the known characteristics of the skin effect. At DC and low frequency, resistive losses in the wire dominate over any impedance caused by the mutual inductance, whereas at high frequency this mutual impedance dominates, giving rise to imbalanced current flow.

Using this electrical model as a guide, it would be logical to increase the outer conductor impedance so as to reduce the current preferentially flowing in the outer conductors. Increasing the resistance of the outer conductors would be counterproductive, as the energy flowing therein would be wasted as heat. Therefore, a low-loss inductive impedance should be introduced into each branch of the system, with such impedance varying according to the distribution of mutual inductance across the branches. To counter the skin effect, the physical distribution requires that large inductances be placed on the outer conductors, and, furthermore, that the inductance should taper off exponentially as the center conductor is reached. This impedance will act to equalize the currents flowing in each branch, countering the mutual inductance between the layers and thereby countering the skin effect itself. Even a relatively small or incomplete equalization of the branch impedances will have a profound effect on total system loss; this is due to the large variation of effective conductor area with respect to branch current imbalance.

While it may be obvious to install discrete inductors in each branch to accomplish the desired equalization, this approach fails for several reasons. The inductors will, by necessity, contain a relatively small conductor cross-sectional area compared to the main laminated conductor stack, as well as possess considerable internal wire length, thereby causing unacceptable loss. Other reasons include difficulty of manufacturing, and the conversion of the resultant system from a true distributed impedance to a partially lumped impedance; the latter problem, especially, would severely limit usefulness of the system at high frequencies.

Therefore, it is advantageous to utilize distributed impedance modification of the outermost layers. This can be achieved through the use of the aforementioned magnetic film; such a film can be effectively continuous and constant along the length of the system, preserving the desirable distributed properties of the system. The magnetic film, when applied with specific thickness and distance from the conductor stack, acts to increase the inductance of the outermost conductors while having little or no effect upon the innermost conductors, thus achieving the desired equalization of branch impedances.

Given the high level of impedance equalization possible with this method, and the fact that the lumped circuit properties of the conductor stack are purposefully left unused, the use of laminated conductors is not required. The present invention will reduce the skin-effect losses even if a solid rectangular conductor is utilized, provided that the magnetic film distance and thickness are properly matched to the physical dimensions of that specific conductor. This should be obvious when the cause of the eddy currents is considered; namely, that a voltage differential exists through the depth of the conductor when the skin effect is occurring. When the skin effect is compensated for, as previously described, this voltage differential is greatly reduced or nonexistent. When the voltage differential does not exist, the insulating films no longer have a purpose and can be removed safely with no effect upon the system.

Without limiting the scope of the invention, several problems in the prior art and their solution in this invention are discussed herein. With respect to the problem of severe power loss of high frequency signals due to skin effect, a new method has been described to reduce and/or eliminate the skin effect and, thereby, the loss associated with it. With respect to the problem of distortion caused by skin-effect related delay in the inner portions of the conductor, a new method has been described to reduce and/or eliminate the skin effect and, thereby, the distortion associated with it. The present invention also enables high frequency, high magnetic field generation, as it reduces the undesired skin-effect losses without significantly affecting the intensity or distribution of the magnetic field produced outside the wire when high frequency electrical current is applied.

### BRIEF DESCRIPTION OF THE SEVERAL VIEWS OF THE DRAWING

FIG. 1 is a perspective view of one embodiment of the present invention.

FIG. 2 is a sectional view of another embodiment of the present invention.

FIG. 3 is a perspective view of another embodiment of the present invention.

FIG. 4 is a sectional view of the preferred embodiment of the present invention.

FIG. 5 is a perspective, cutaway view of the preferred embodiment of the present invention.

FIG. 6 is a top view of the present invention, illustrating the section line associated with FIG. 2 and FIG. 4.

### DETAILED DESCRIPTION OF THE INVENTION

While the design and usage of specific embodiments are discussed below, it should be understood that these discussions do not limit the scope of this invention, and that the broad concepts which are part of this invention may be usable in other specific embodiments which are not discussed below.

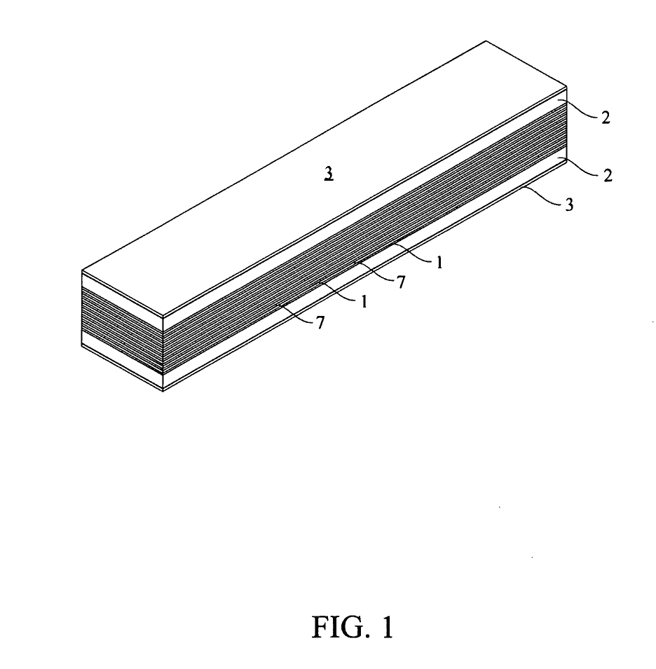

The skin-effect compensator of the present invention includes a conductor or conductors 1 through which electrical signals are transmitted. Also provided are electrical insulators 2, and a material or materials with a relative permeability greater than one 3, hereinafter referred to as compensators. In one embodiment of the present invention, multiple layers of conductive material 1 are interleaved with multiple insulators 7 in order to isolate each conductor from any adjacent conductors. This embodiment is shown in FIG. 1 of the drawings, and also includes insulators 2 on the top and the bottom of the structure. The insulators 2 act to electrically and physically separate compensators 3 from the conductive elements 1 contained within the structure. The thickness of the insulators 2 and the compensators 3 must be precisely controlled, and will vary as the dimensions of the overall structure are altered. The compensators 3 must have an electrical resistance which is significantly higher than the conductors 1 in order to prevent the formation of undesired eddy currents within the compensator material.

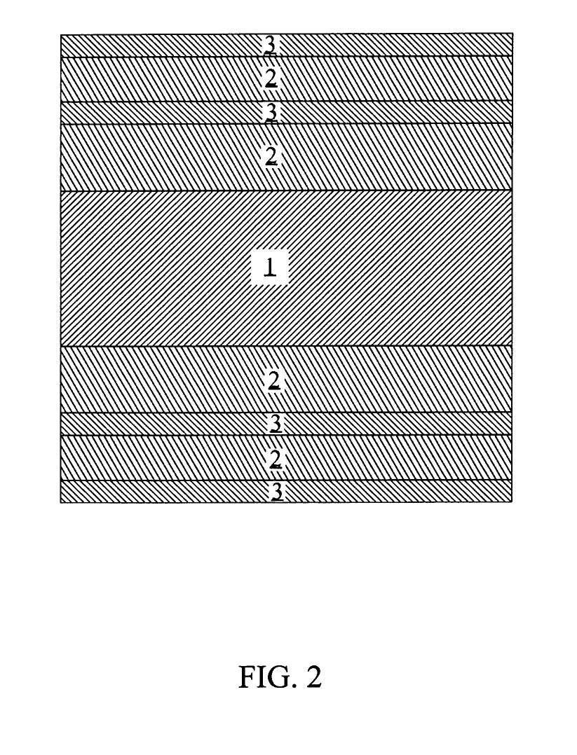

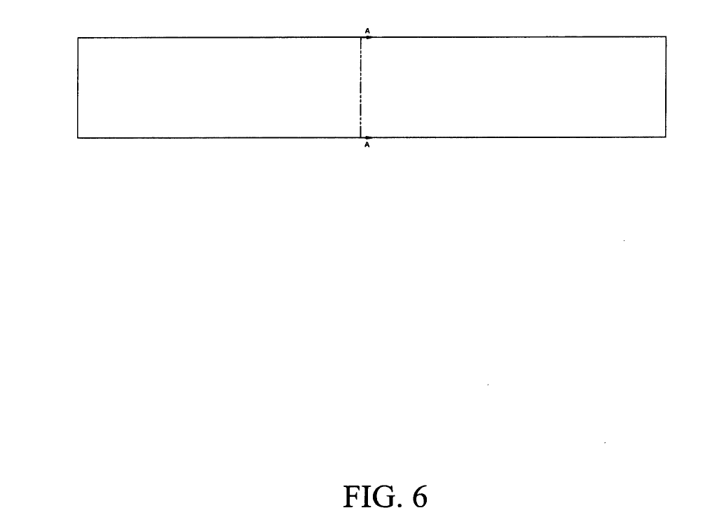

In another embodiment of the invention, multiple compensator layers are utilized to further reduce the skin effect within the conductors 1. Referring to the drawings, FIG. 2 is a sectional view of this embodiment cut along the line shown in FIG. 6, illustrating the use of multiple compensators 3, each being separated from adjacent structures via the use of insulators 2. Additionally, the laminated conductive structure of the prior embodiment has been replaced with a single, solid conductor 1. The thickness of each insulator 2 and compensator 3 may vary from layer to layer, in accordance with the geometry of the structure and the desired reduction of skin-effect losses. While the use of two compensator layers and a solid center conductor is illustrated in FIG. 2, it should be understood that a plurality of compensator layers and/or a laminated conductor may be utilized without deviation from the scope of this invention. As above, the compensators 3 must be comprised of a high-resistance material to avoid power loss within the compensator layers.

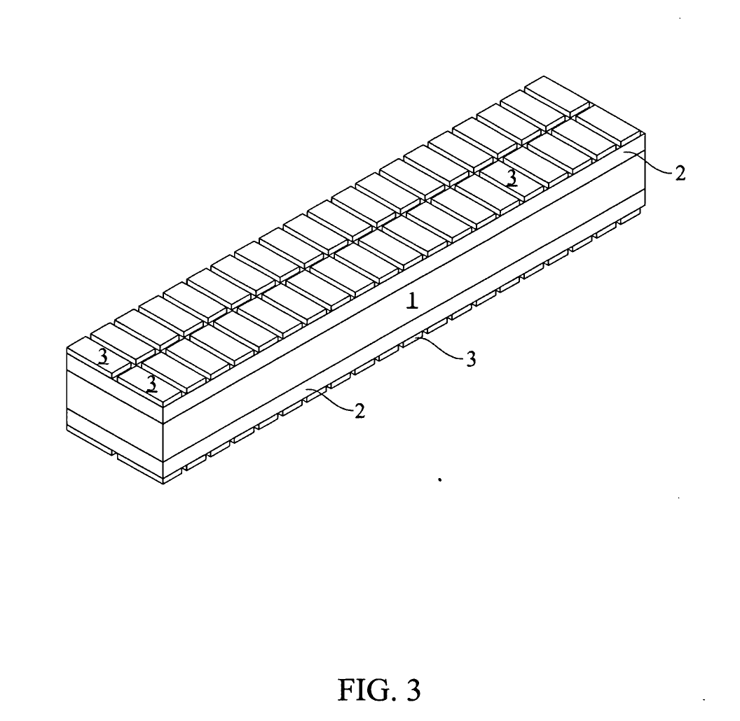

In another embodiment of the invention, the compensators 3 are segmented as shown in FIG. 3 of the drawings, and each segment is electrically isolated from any adjacent segments. This permits the use of a highly conductive material for the compensators, as it acts to prevent the formation of undesired eddy currents within the compensator material. This compensator design may be applied to all embodiments of the present invention, including those utilizing multiple compensator layers.

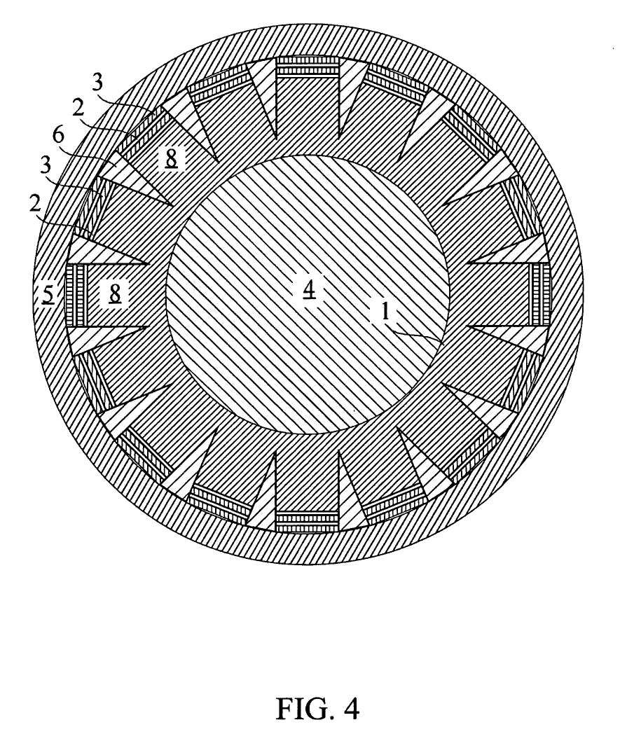

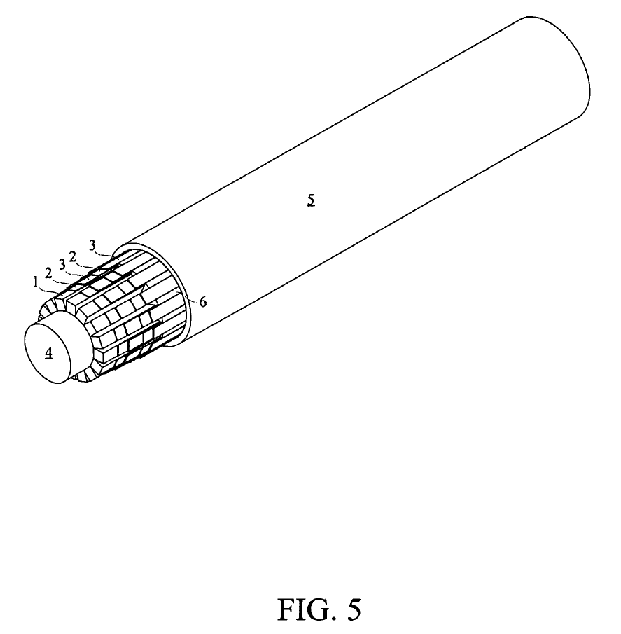

In the preferred embodiment of the invention, a plurality of rectangular protrusions 8 are provided on the surface of a circular conductor 1. A plurality of insulator 2 and compensator 3 layers are provided above each protrusion, with the net effect being a reduction in the skin-effect experienced within each protrusion. Flexible insulating structures 6 are provided between each protrusion to enhance mechanical rigidity, and a flexible outer insulation 5 is provided in the manner of a standard wire. In one embodiment of the invention, materials 5 and 6 are identical, and their structures are seamlessly merged. In another embodiment of the invention, a central material 4, such as steel cable, is provided for mechanical rigidity. In another embodiment of the invention, central cavity 4 is left unfilled, or filled with an inert gas or fluid for cooling purposes. Referring to the drawings, FIG. 4 is a sectional view of this embodiment cut along the line shown in FIG. 6, and FIG. 5 is a cutaway perspective view of the preferred embodiment, illustrating the various layers utilized.

It should be apparent that an improved electrical conductor may be utilized for many different applications as well known in the art, and that these applications are too numerous to fully list here. Without limiting the scope of the invention, several potential applications will be mentioned below. The structure shown in FIG. 5 is readily used as a conductor for a radio frequency coaxial or triaxial cable, as is well known in the art. In addition to being used as a center conductor, a larger variant of the same structure may be utilized for the various shielding layers of said cable. The structures shown in FIG. 1, FIG. 2, and FIG. 3 may have applications in microelectronics, to reduce the loss of high frequency interconnects. The embodiment shown in FIG. 5 is readily used for low-loss electrical power transmission, for example, at high electrical and mechanical tension and at low frequencies, such as 50 or 60 Hz. The performance of all embodiments will be enhanced by the use of low-resistance conductive materials, such as superconductors, although they also will function with the use of readily available conductive materials such as copper or silver. All embodiments may be insulated with an external, conformal insulation material for electrical isolation and mechanical durability, as is well known in the art.

What I claim:

1. A device for reducing the skin-effect losses of an electrical conductor, consisting of:
an electrical conductor of rectangular cross section;
one or more compensators, consisting of a material with relative magnetic permeability greater than one and acting to selectively alter inductance with depth into said conductor; and
one or more electrical insulators, placed to electrically isolate any present compensators from other device components, and to maintain said compensators at a specified physical distance from other device components.

2. A device for reducing the skin-effect losses of an electrical conductor, consisting of:
an electrical conductor of arbitrary cross section, where a plurality of rectangular protrusions are provided on the outer surface of said conductor;
one or more compensators, consisting of a material with relative magnetic permeability greater than one and acting to selectively alter inductance with depth into said conductor; and
a plurality of electrical insulators, placed to electrically isolate any present compensators from other device components, and to maintain said compensators at a specified physical distance from other device components.

3. The device of claim 2, where a plurality of electrical insulators are provided in the spaces between protrusions.

4. The device of claim 2, where a structural material is provided within the electrical conductor to increase mechanical strength of the resultant device.

5. The device of claim 2, where a hollow cavity is provided within the electrical conductor.

6. The device of claim 3, where a structural material is provided within the electrical conductor to increase mechanical strength of the resultant device.

7. The device of claim 3, where a hollow cavity is provided within the electrical conductor.

8. The device of claim 5, where a gas or fluid is used to fill the cavity and said fill material may be circulated through the device via an external pump.

9. The device of claim 7, where a gas or fluid is used to fill the cavity and said fill material may be circulated through the device via an external pump.

10. A device for reducing the skin-effect losses of an electrical conductor, consisting of:
a plurality of electrical conductors, each having thickness much less than length or width;
a plurality of electrical insulators, each having thickness much less than length or width;
a laminated conductor of rectangular cross section, comprised of a plurality of conductors and insulators, where the material type is alternated from layer to layer;
one or more compensators, consisting of a material with relative magnetic permeability greater than one and acting to selectively alter inductance with depth into said conductor; and
one or more electrical insulators, placed to electrically isolate any present compensators from other device components, and to maintain said compensators at a specified physical distance from other device components.
